(19) United States
(12) Patent Application Publication
(10) Pub. No.: US 2025/0178882 A1
(43) Pub. Date: Jun. 5, 2025

(54) DEVICE FOR SUSPENDING A BRIDLE AND USE OF A DEVICE

(71) Applicants: CHRISTOPH FRANZIUS, VAREL (DE); ANNA LENA DUVENECK, TWISTRINGEN (DE)

(72) Inventors: CHRISTOPH FRANZIUS, VAREL (DE); ANNA LENA DUVENECK, TWISTRINGEN (DE)

(21) Appl. No.: 18/843,272

(22) PCT Filed: Feb. 17, 2023
(86) PCT No.: PCT/DE2023/200035

§ 371 Date: Sep. 2, 2024

(30) Foreign Application Priority Data
Mar. 3, 2022 (DE) 20 2022 101 171.0

(51) Int. Cl. B68B 9/00; A01L 15/00

(52) U.S. Cl. CPC B68B 9/00; A01L 15/00

(57) ABSTRACT

A device for suspending an object such as bridle, a snaffle, and a halter. The device includes a base body having a wall contact section, a support section, an outer surface which faces away from the contact section, and a fastening device having a magnet. The wall contact section is mounted on a wall section via the fastening device and is associated with the wall section when assembled. The support section is oriented against gravity and supports the object from a direction of the outer surface so that the object is suspended in a supported position on the support section and held against gravity. The magnet is mechanically received in or on the base body and is associated with the wall contact section. The magnet enables a mounting of the base body to a metal wall section via a holding force of the magnet.

### CROSS REFERENCE TO PRIOR APPLICATIONS

This application is a U.S. National Phase application under 35 U.S.C. § 371 of International Application No. PCT/DE2023/200035, filed on Feb. 17, 2023 and which claims benefit to German Patent Application No. 20 2022101 171.0, filed on Mar. 3, 2022. The International Application was published in German on Sep. 7, 2023 as WO 2023/165663 A1 under PCT Article 21(2).

### FIELD

The present invention relates to a device for suspending a bridle, in particular a snaffle holder and/or a halter holder, the device having at least one base body, wherein the base body has at least one wall contact section, a support section and an outer surface facing away from the wall contact section, wherein the wall contact section can be mounted on a wall section via a fastening device and is associated with the wall section in an assembled position, and wherein the support section is oriented against the direction of gravity and is set up to support a snaffle and/or a halter from the direction of the outer surface, so that the snaffle and/or the halter is or are suspended on the support section in a supported position and held against the direction of gravity. The present invention also relates to the use of such a device for suspending a bridle.

### BACKGROUND

In stables, exercise pens, box stalls and other animal housing facilities, in particular for horses or other domesticated animals used, for example, for riding, there is a need to provide bridles, such as snaffles or halters, for the animals, ready to hand for a carer or rider. Snaffle holders or halter holders are known for this purpose which are, for example, attached to building walls, stall partitions, stall fronts or wooden partitions, and on which the bridle can be hung. Screws are, for example, used to attach such devices. There is often the problem that, for example, horses are stabled in third-party stables and therefore no permanent changes may be made to structural installations. For these cases, snaffle holders or halter holders are known, for example, which are hooked or clamped into place. Such snaffle holders or halter holders are hung, for example, on stall partitions, on the front side of front walls or in other suitable places near a horse and secured by gravity. Such solutions often protrude into the horse stalls and can also be thrown off by animals. There is also often a risk of injury to the animals.

DE 10 2005 008 227 A1 describes a saddle and bridle holder. A horse-head-like steel body is mounted at an angle on a wall in order to hold a saddle and bridle. The steel body can be screwed to a wall via a plate. The construction is also suitable for playfully sitting on a saddle and, for example, simulating riding a horse for children.

DE 202 14 204 U1 describes a saddle holder. A cantilever beam is there used to hold the saddle. The device protrudes very far out of a wall and is screwed to a retaining plate, for example, on a wall.

US 2008/0105632 A1 describes a support frame for riding accessories. The frame is hung over a fence or a stall partition, for example, using U-shaped clamps, so that bridles and riding accessories can be hung on hooks.

### SUMMARY

An aspect of the present invention is to improve upon the prior art.

In an embodiment, the present invention provides a device for suspending an object such as a bridle, a snaffle and a halter. The device includes at least one base body which comprises at least one wall contact section, a support section, an outer surface which faces away from the at least one wall contact section, and a fastening device which comprises a first magnet. The at least one wall contact section is configured to be mounted on a wall section via the fastening device and is associated with the wall section in an assembled position. The support section is oriented against a direction of gravity and is configured to support the object from a direction of the outer surface so that the object is suspended in a supported position on the support section and held against the direction of gravity. The first magnet is mechanically received in or on the at least one base body and is associated with the at least one wall contact section. The first magnet is configured to enable a mounting of the at least one base body to a metal wall section via a holding force of the first magnet.

### BRIEF DESCRIPTION OF THE DRAWINGS

The present invention is described in greater detail below on the basis of embodiments and of the drawings in which:

FIG. 1 is a perspective view of a bridle holder mounted on a stall partition;

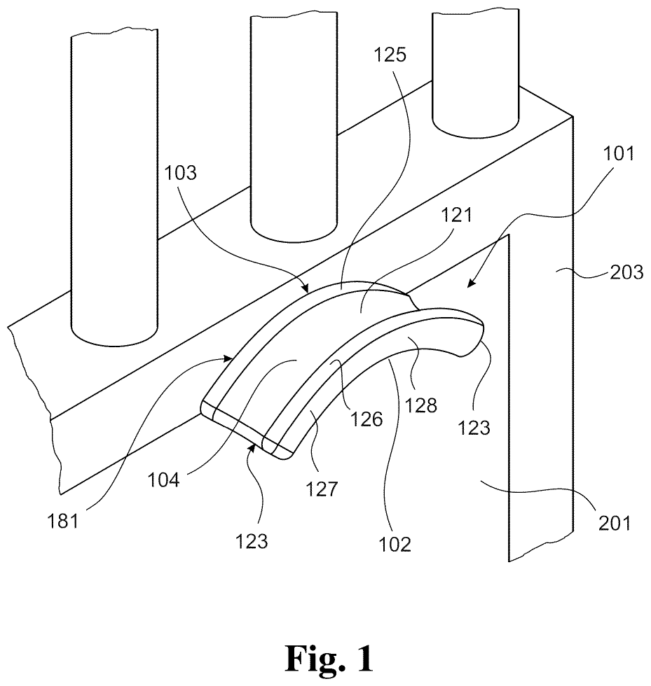

FIG. 2 is a schematic side view of the bridle holder of FIG. 1;

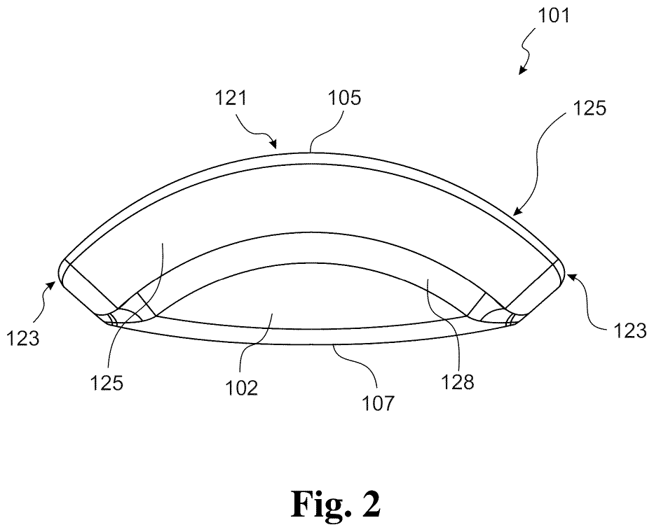

FIG. 3 is a schematic side view of the bridle holder of FIG. 1 from a rear perspective compared to FIG. 2;

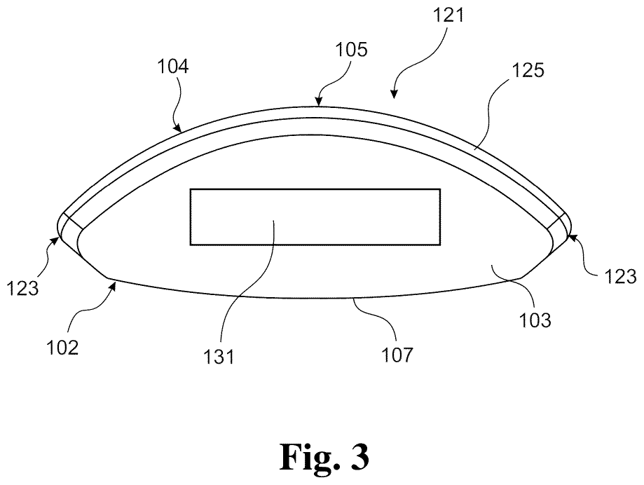

FIG. 4 is a schematic sectional view through the bridle holder of FIGS. 1 to 3;

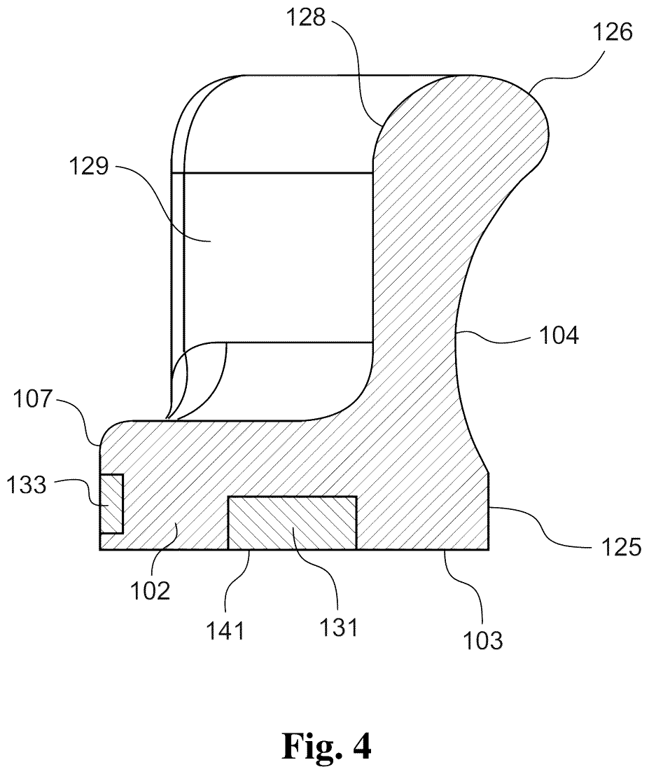

FIG. 5 is a schematic side view of the bridle holder in an extended application; and

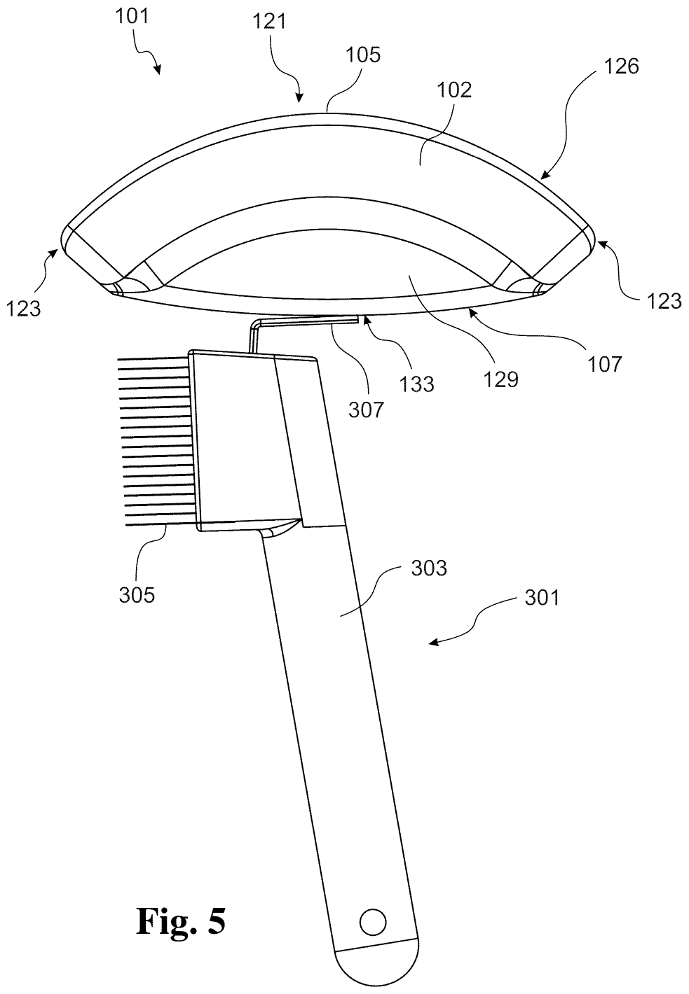

FIG. 6 is a perspective view of the alternative application of the bridle holder in FIG. 5.

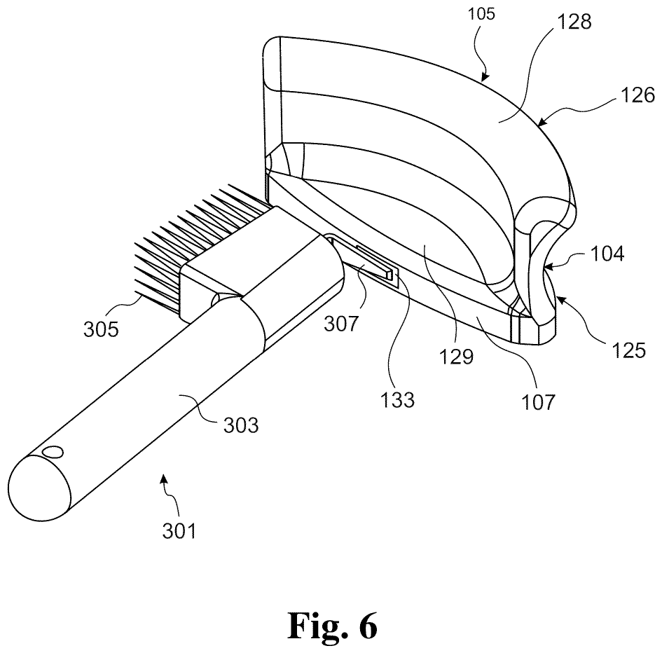

### DETAILED DESCRIPTION

The present invention provides a device for suspending a bridle, in particular a snaffle holder and/or a halter holder, having at least one base body, wherein the at least one base body has at least one wall contact section, a support section and an outer surface facing away from the wall contact section, wherein the wall contact section can be mounted on a wall section via a fastening device and is associated with the wall section in an assembled position, and wherein the support section is oriented against the direction of gravity and is set up to support a snaffle and/or a halter from the direction of the outer surface, so that the snaffle and/or the halter is or are suspended in a supported position on the support section and held against the direction of gravity, wherein the fastening device comprises a first magnet, wherein the first magnet is mechanically received in or on the at least one base body and is associated with the wall contact portion and enables mounting of the at least one base body to a metal wall section via a holding force of the first magnet.

This means that a corresponding device can be mounted only using magnetic forces, for example, on widely used stall partitions, stall fronts, wall protection paneling or the like that are at least partially made of metal, particularly in animal housing facilities for horses. The design of the fastening device with a first magnet also makes it possible to use the corresponding device flexibly without leaving damage or marks on the respective wall sections. With a correspondingly flat design between the wall contact section and the outer surface, the device can furthermore be designed so that it protrudes as little as possible into an animal holding area and thus cannot, for example, be detached by animals or can only be detached with difficulty.

The following terms are explained in this context:

A “device for suspending a bridle” refers to a device that is suitable for suspending a “bridle”, i.e., linen-like knitted fabrics for leading riding and draft animals. Such a bridle has a so-called head frame made of straps for the animal's head as well as so-called lead ropes and/or reins, which can be guided by the rider's hand in order to lead the animal. “Snaffles”, i.e., bridles with a bit guide, and “halters”, i.e., bridles without a bit guide, are in particular known. The different types of bridle have in common that they often consist of a large number of straps, for example, made of leather or textile strip, and are therefore very cumbersome to suspend. In this context, “suspend” in particular refers to the temporary placement of the bridle in a fixed position, in particular held only by gravity.

A “base body” refers to a body that substantially forms the device and can be made, for example, of plastic, wood or metal. It should be noted that “the base body” is at least one base body but can also be formed from several base body parts, for example, to simplify the manufacture and/or packaging of the device. Several base body parts joined together form the base body, wherein, for example, individual functions or functional components of the base body can in this case be accommodated on or in different base body parts. Where reference is hereafter made to the “base body”, an alternative with several base body parts is therefore also covered. The base body is shaped so that a “wall contact section” is provided which can be arranged on a “wall section”, i.e., for example, on a metal component or a metal plate. The wall contact section is in particular substantially flat or partially flat so that a planar contact with the respective wall section is possible. A “support section” is in contrast such a physical section of the base body or a physical area arranged on the base body on which the corresponding bridle can be placed in order to temporarily suspend it. Opposite the wall contact section, i.e., substantially facing away from the wall contact section, there is arranged an “outer surface”, which need not have a specific shape. The outer surface faces an operator and is oriented in the direction from which the corresponding bridle can be suspended on the device.

A “fastening device” in this context is any device via which the wall contact section can be mounted on the wall section. Such a fastening device can, for example, be a screw or a hook, particularly in the case of generic devices. The present invention here provides a “magnet”, i.e., a body which generates a magnetic field in its environment and can thus, for example, generate a magnetic attraction to metal objects. Each magnet generates a corresponding “holding force” which acts as a mechanical holding force of the magnet on a metal surface or a metal object. The “assembled position” refers to the usual operating position of the device according to the present invention in which the wall contact section is attached to the wall section, i.e., “mounted associated therewith”, and the holding force takes effect.

The support section is oriented against the direction of gravity, i.e., so that the bridle can rest on the support section held only by gravity and does not, for example, slip. At least part of the support section is in particular level or substantially level, i.e., horizontal. “Set up to support a snaffle and/or a halter from the direction of the outer surface” in this context refers to a configuration of the support section so that the bridle can be guided in the direction of the wall section and then placed on the support section; the support section can, for example, be shaped so that a stable condition is created with the bridle in place.

The “supported position” in this context describes a position of the bridle that is suitable for use, in which, for example, one or more straps or strands of the bridle lie on the support section and the bridle is suspended from a steel wall so that contact with the ground and the associated dirtying can be ruled out.

According to the present invention, the first magnet is “mechanically received in or on the base body”, for example, pressed into the base body, glued to the base body or connected to the base body via a screw connection so that the magnetic forces emitted by the magnet are mechanically transmitted to the base body, so that the magnet serves as a holding device, i.e., as a fastening device, for the base body on a metal surface. The magnet can also, for example, be directly over-molded with a plastic in a base body embodied as a plastics injection-molded part or otherwise embedded in the base body or in one or more of the base body parts.

In order to enable the device to be adapted to different substrates or to metal structures having different adhesive strengths, the fastening device can, for example, have a second magnet, a third magnet and/or a further magnet, wherein the second magnet, the third magnet and/or the further magnet is or are mechanically received in the base body and is/are associated with the wall contact section, thus enabling the base body to be mounted on the metal wall section via a holding force of the second magnet, the third magnet and/or the further magnet. A respective holding force or the sum of holding forces of different magnets can, for example, be dimensioned so that a corresponding total holding force is sufficient to securely hold the weight of the device and the weight of the halter and/or bridle. The total holding force can, for example, be twice or even three times the holding force required in the static application case so that the device is reliably prevented from tearing off or falling off due to external forces when the halter or bridle is removed.

The second magnet, the third magnet and/or the further magnet can be mechanically received in the base body, in particular in different geometric arrangements, so that, for example, a rectangular arrangement spans the largest possible support area and/or, for example, frequently occurring geometries on stable walls, such as T-shaped connections of steel beams, are reproduced by corresponding arrangement patterns.

In an embodiment of the present invention, the first magnet, the second magnet, the third magnet and/or the further magnet is or are in particular completely embedded in the wall contact section.

“Completely embedded” here refers to a state in which the respective magnet is substantially completely received within a local enveloping contour of the wall contact section so that no or only minimal components of the respective magnet protrude beyond the wall contact section. This means that the respective magnets are mechanically protected in the wall contact section in the best possible way and can develop their best possible holding force together with the wall contact section due to their planar contact. The respective magnet can alternatively also be surrounded by a part of the wall contact section or in a part of the base body or base body part forming the wall contact section, for example, in a base body formed by injection molding.

The first magnet, the second magnet, the third magnet and/or the further magnet, in particular an outer side of the respective magnet facing the wall section, in particular forms or form a partial wall section of the wall contact section. A direct or a substantially direct contact of the respective magnet can, for example, be achieved to shorten a distance to zero at best, whereby the holding force of the respective magnet is fully and optimally formed. Technically induced deviations or, for example, a minimal overlap of the magnet with a part of the base body are here included.

In an embodiment of the present invention, the support section can, for example, be curved in the assembled position against the direction of gravity so that the support section is formed as a curved section and a respective edge section of the curved section is arranged along the direction of gravity below a center section of the curved section.

Such a curvature, which is designed in the same way as, for example, a bridge arch, supports the secure placement and holding of the bridle so that slipping is as unlikely as possible. It also provides a high level of comfort and the best-possible protection of the bridle.

“Against the direction of gravity” describes the direction “upwards” in a usual position of the device, whereby respective edge sections, i.e., areas arranged substantially parallel to the wall section on both sides of a center section, are arranged below the respective center section.

A curvature direction of the curved section is in particular parallel or substantially parallel to the wall contact section, and thus a curvature axis is orthogonal or substantially orthogonal to the wall contact section, so that the bridle and/or the halter is arranged parallel or substantially parallel to the wall section in the supported position. A device that protrudes as flat as possible from the respective wall section can be created with this design, which makes it very unlikely that the bridle will be torn off, for example, by a horse or a rider. This minimizes the risk of injury to a horse in particular, for example, if the outer surface is curved and/or rounded.

In an embodiment of the present invention, a first edge bead and/or a second edge bead is associated with the support section, wherein the respective edge bead is designed to protrude against the direction of gravity in relation to the support section, so that a slipping of the bridle, in particular the snaffle or halter, in the direction of the wall contact section and/or in the direction of the outer surface is made more difficult and/or altered in the supported position.

Such an “edge bead” is a volumetrically protruding bead, for example, along a transition line between the contact section and the outer surface, which forms an edge for the bridle that needs to be overcome against the direction of gravity in order to move the bridle over this edge bead. This prevents the bridle from unintentionally falling down.

In order to be able to pick up tools, for example, scraping tools or other hoof treatment tools, directly on the device, an additional magnet or several additional magnets is or are associated with an outer contact surface of the base body, wherein the additional magnet is set up and/or arranged to pick up and hold a metal tool on the outer contact surface. The outer contact surface can, for example, be arranged in the outer surface or also on a further surface of the base body so that metal tools can be attached to the outer surface of the device or below the device with magnetic holding forces, for example, via the additional magnet or via the additional magnets. The additional magnet is in this case arranged close to a respective outer contact surface, for example, so that corresponding holding forces are sufficient and/or a distance to the metal tool in a holding position is small enough to hold the metal tool.

In an embodiment of the present invention, the respective additional magnets can, for example, be associated with the outer surface and/or arranged in the outer surface so that the outer contact surface is arranged on the outer surface.

In an embodiment of the present invention, the additional magnet or the additional magnets is or are, for example, embedded flush in the outer contact surface, in particular in the outer surface.

In an embodiment of the present invention, the first magnet, the second magnet, the third magnet and/or further magnet, the additional magnet and/or the additional magnets can, for example, comprise a neodymium magnet and/or a pot magnet. A “neodymium magnet” here refers to a magnet that is in particular made from an alloy of neodymium, iron and boron and has a particularly strong permanent magnetic holding force. A “pot magnet” refers to a pot-shaped magnet which, due to its geometry, has a particularly advantageous arrangement of magnetic lines and thus an increased holding force compared, for example, to flat magnets.

The present invention also provides for the use of a device according to the previously described embodiments for suspending a bridle, in particular for suspending a snaffle and/or a halter.

This makes it particularly easy and safe to support a bridle so that, for example, a rider can safely stow the bridle when grooming or preparing a horse without endangering the animal or without risk of the bridle falling off.

The present invention is further described below via exemplary embodiments as shown in the drawings.

A bridle holder 101 has a one-piece base body 102, which forms a wall contact section 103 in the form of a smooth surface. With the wall contact section 103, the bridle holder 101 is attached to a box partition 201, in this case to a metal frame 203. The box partition 201 is here shown as an example; a box front wall and/or another metal arrangement can, for example, also be used. The base body 102 forms a curved support section 104 approximately orthogonal to the wall contact section 103 which is molded upwards in the form of a curved section 105. On an underside, the base body 102 has a lower edge 107, which is slightly curved downwards for aesthetic reasons.

The curved section 105 is formed with a central elevation 121 and end regions 123 sloping downwardly from the central elevation so that an upwardly curved support section 104 is formed, for example, for supporting bridles.

In the direction of the wall contact section 103, an edge 125 is arranged along the curved section 105 which is substantially horizontal. This edge 125 nestles along the curved section 105 so that a curved, cylindrical surface is formed. In the direction of an outer surface 127 on the base body 102 facing away from the wall contact section 103, an edge bead 126 is formed to terminate the support section 104. The edge 125 as well as the edge bead 126 thus, for example, limit on both sides a falling down of the bridle which is suspended on the bridle holder 101 and also limit the channel-shaped cross-section of the support section 104. The support section 104 is thus formed as an arched channel.

Below the support section 104, i.e., on an underside of the base body 102, there is arranged an inner curvature 128 which forms the transition from the edge bead 126 in the direction of a free space 129. The bridle holder 101 is thus hollowed out on the underside so that the weight of the bridle holder 101 is reduced.

A magnet 131 is pressed into the wall contact section 103 and, with a contact surface formed flush with the wall contact section 103, enables a magnetic attachment to the frame 203 of the box partition 201 with a contact 181. It should here be mentioned that the magnet 131 is shown as a single magnet by way of example, however, a plurality of magnets can also be embedded or arranged in the region of the wall contact section 103, for example, in order to support a higher weight or a higher load or to form a larger contact area spanned by the magnets.

A further magnet 133 is embedded in the region of the lower edge 107 and enables a metal tool, in this example a hoof scraper 301, to be supported. For this purpose, the further magnet 133 in the example shown here is recessed substantially flush with the lower edge 107 in the base body 102 and enables the hoof scraper 301, which has a handle 303 and a brush 305, to be suspended from a metal scraper hook 307 that is also arranged on the hoof scraper 301. Such a magnet analogous to the further magnet 133 can be arranged both in the region of the lower edge 107 and, for example, in the region of the inner curvature 128 and/or the free space 129 in order to be able to magnetically suspend further or other tools.

The bridle holder 101 is configured as follows:

The bridle holder is carried in a rider's grooming box, for example, and can then be magnetically attached to any metal object, such as the frame 203, for example, in a livery stable or boarding stable, by bringing the wall contact section into contact with the frame 203 and by firmly attaching the bridle holder 101 to the frame 203 via the holding force or the adhesive force of the magnet 131. The central elevation 121 is here orientated upwards so that the support section 104 points upwards. A bridle, such as a halter or snaffle, can then be hung over the channel-shaped support section 104 so that the bridle does not lie on the ground and, for example, become dirty. Other tools removed from the grooming box, such as the brush 305, can then be arranged on the further magnet 133 or another magnet arranged similarly, so that the hands remain free to groom a horse with a brush, for example, and still have quick access to the brush 305.

The present invention is not limited to embodiments described herein; reference should be had to the appended claims.

### LIST OF REFERENCE NUMERALS

101 bridle holder
102 base body
103 wall contact section
104 support section
105 curved section
107 lower edge
121 central elevation
123 end region
125 edge
126 edge bead
127 outer surface
128 inner curvature
129 free space
131 magnet
133 further magnet
141 contact surface
181 contact
201 box partition
203 frame
301 hoof scraper
303 handle
305 brush
307 scraper hook

What is claimed is:

1-12. (canceled)

13. A device for suspending an object, the device comprising:
at least one base body which comprises,
at least one wall contact section,
a support section,
an outer surface which faces away from the at least one wall contact section, and
a fastening device which comprises a first magnet,
wherein,
the at least one wall contact section is configured to be mounted on a wall section via the fastening device and is associated with the wall section in an assembled position,
the support section is oriented against a direction of gravity and is configured to support the object from a direction of the outer surface so that the object is suspended in a supported position on the support section and held against the direction of gravity,
the first magnet is mechanically received in or on the at least one base body and is associated with the at least one wall contact section, and
the first magnet is configured to enable a mounting of the at least one base body to a metal wall section via a holding force of the first magnet.

14. The device as recited in claim 13, wherein the object is a bridle, a snaffle, and/or a halter.

15. The device as recited in claim 13, wherein,
the support section is curved in the assembled position against the direction of gravity so that the support section is formed as a curved section, and
the curved section comprises a center section and two edge sections, each of the two edge sections being arranged along the direction of gravity below the center section.

16. The device as recited in claim 15, wherein a curvature direction of the curved section is parallel or substantially parallel to the at least one wall contact section, so that a curvature axis is orthogonal or substantially orthogonal to the at least one wall contact section, so that the object is arranged parallel or substantially parallel to the at least one wall section in the supported position.

17. The device as recited in claim 15, wherein,
the at least one base body further comprises at least one of a first edge bead and a second edge bead which is or are associated with the support section, and
the at least one of the first edge bead and the second edge bead are arranged to protrude against the direction of gravity in relation to the support section so that a slipping of the object in a direction of at least one of the at least one wall contact section and of the outer surface is at least one of made more difficult and prevented in the supported position.

18. The device as recited in claim 13, wherein,
the fastening device further comprises at least one of a second magnet, a third magnet and a further magnet, and
the at least one of the second magnet, the third magnet, and the further magnet is or are mechanically received in the at least one base body and is or are associated with the at least one wall contact section so as to provide the mounting of the at least one base body on the metal wall section via at least one of a holding force of the second magnet, a holding force of the third magnet, and a holding force of the further magnet.

19. The device as recited in claim 18, wherein at least one of the first magnet, the second magnet, the third magnet, and the further magnet is or are completely embedded in the at least one wall contact section.

20. The device as recited in claim 18, wherein the at least one of the first magnet, the second magnet, the third magnet, and the further magnet, forms or form a partial wall section of the at least one wall contact section.

21. The device as recited in claim 20, wherein an outer side of the at least one of the first magnet, the second magnet, the third magnet, and the further magnet, respectively, which faces the at least one wall section, forms or form the partial wall section of the wall contact section.

22. The device as recited in claim 18, wherein,
the at least one base body further comprises,
an additional magnet or several additional magnets, and
an outer contact surface comprising a lower edge and an inner curvature,
the additional magnet or the several additional magnets are associated with the outer contact surface, and
the additional magnet or the several additional magnets is or are configured to pick up and hold a metal tool on the outer contact surface.

23. The device as recited in claim 22, wherein the additional magnet or the additional magnets is or are associated with the outer surface and/or are arranged in the outer surface so that the outer contact surface is arranged at the inner curvature.

24. The device as recited in claim 22, wherein the additional magnet or the additional magnets is or are embedded flush in the outer contact surface.

25. The device as recited in claim 24, wherein the additional magnet or the additional magnets is or are embedded flush in the inner curvature.

26. The device as recited in claim 22, wherein the at least one of the first magnet, the second magnet, the third magnet, the further magnet, the additional magnet, and the additional magnets, comprises or comprise at least one of a neodymium magnet and a pot magnet.

27. A method of using the device as recited in claim 13, the method comprising:
providing the device as recited in claim 13; and
using the device to suspend an object.

28. The device as recited in claim 27, wherein the object is a bridle, a snaffle, and/or a halter.
